(19) United States
(12) Patent Application Publication
(10) Pub. No.: US 2008/0292927 A1
(43) Pub. Date: Nov. 27, 2008

(54) Humidity controllable cathode end plate and air breathing fuel cell stack the same

(76) Inventors: Seong-Jin An, Suwon-si (KR); Seok-Rak Chang, Suwon-si (KR); Gill-Tae Roh, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/070,668

(22) Filed: Feb. 19, 2008

(30) Foreign Application Priority Data
Apr. 24, 2007 (KR) 10-2007-0039834

(51) Int. Cl. H01M 8/04

(52) U.S. Cl. 429/22

(57) ABSTRACT

The present embodiments relate to a humidity controllable cathode end plate and an air breathing fuel cell stack using the same capable of preventing stack performance degradation due to the dryness of a cathode and a membrane. The air breathing fuel cell stack according the present embodiments including: a membrane electrode assembly configured of an anode, a cathode, and an electrolyte membrane positioned between the anode and the cathode; a fuel supply unit coupled to the anode to supply fuel; and a cathode end plate coupled to the cathode so that the humidity of the cathode is maintained and including a first opening part for influxing ambient air and a second opening part for outfluxing the ambient air.

### CROSS-REFERENCE TO RELATED APPLICATIONS

This application claims the benefit of Korean Patent Application No. 10-2007-0039834, filed on Apr. 24, 2007, in the Korean Intellectual Property Office, the disclosure of which is incorporated herein by reference.

### BACKGROUND OF THE INVENTION

1. Field of the Invention

The present embodiments relate to a humidity controllable cathode end plate and an air breathing fuel cell stack using the same capable of preventing stack performance degradation due to the dryness of a cathode and a membrane.

2. Description of the Related Art

Since a fuel cell is a pollution-free power supply apparatus, it has been spotlighted as one of next generation clean energy power generation systems. It has advantages that a power generation system using the fuel cell can be used in a self-generator for a large building, a power supply for an electric vehicle, a portable power supply, etc. The fuel cell is basically operated with the same principle and is sorted into a molten carbonate fuel cell (MCFC), a solid oxide fuel cell (SOFC), a polymer electrolyte membrane fuel cell (PEFC), a phosphoric acid fuel cell (PAFC), an alkaline fuel cell (AFC), etc., in accordance with an electrolyte used.

Among others, the polymer electrolyte fuel cell (PEFC) is sorted into a polymer electrolyte membrane fuel cell or proton exchange membrane fuel cell (PEMFC) and a direct methanol fuel cell (DMFC) in accordance an electrolyte used. Since the polymer electrolyte fuel cell uses solid polymer as electrolyte, it has no risk of corrosion or evaporation due to the electrolyte and can obtain high current density per unit area. Moreover, since the polymer electrolyte membrane fuel cell is very high in output characteristic and low in an operating temperature as compared to other kinds of fuel cells, it has been actively developed as a portable power supply for supplying power to a vehicle, a distributed power supply for supplying power to a house or a public building, and a small power supply for supplying power to electronic equipments, etc. Since the direct methanol fuel cell directly uses liquid-phase fuel such as methanol, etc. without using a fuel reformer and is operated at an operating temperature less than 100° C., it is advantageous in being suitable for a portable power supply or a small power supply.

A unit cell used for the polymer electrolyte fuel cell outputs voltage of approximately 1V. Therefore, the polymer electrolyte fuel cell is manufactured with a structure that a plurality of unit cells are electrically connected in series to be able to output any voltage higher than 1V. As the structure that the plurality of unit cells are electrically connected in series, there are a general stack structure that a membrane electrode assembly (MEA) and a bipolar plate (BP) (or referred to as a separator) is alternatively stacked, and a flat plate type or an air breathing type stack structure that a plurality of unit cells arranged on a plane is electrically connected in series. The general stack structure is referred to as an active type stack structure. It has an advantage that the general stack structure does not require separate wirings for electrically connecting between the unit cells since the BP serves as an electrical connector. The air breathing type stack structure is referred to as a semi-passive type or a passive type stack structure. It has an advantage that the air breathing type stack structure can omit an oxidant supplying apparatus since a circulating air is supplied to the cathode by means of natural convection.

Generally, in the air breathing fuel cell the cathode is opened to the air. Accordingly, water generated from the cathode is evaporated in water vapor form so that it is diluted in rich atmosphere. Generally, the water generated from the fuel cell remains in the electrolyte membrane of the MEA to serve as a mediator for conducting protons. However, in the air breathing fuel cell, since the cathode is opened to the air, it has the disadvantage that moisture is not remained in the cathode so that the electrolyte membrane becomes dried.

In particular, when the temperature of the air breathing fuel cell stack is less than 50° C., the stack performance degradation is not generated, however, when the temperature thereof is 50° C. or more, the stack performance is greatly degraded due to the dryness of the cathode and the electrolyte membrane. When the air breathing fuel cell is operated in the state where current density, which has a large effect on the temperature of the stack, is relatively high, it is disadvantageous in that it greatly degrades the stack performance due to the dryness of the cathode and the membrane. The present embodiments overcome the above disadvantages as well as provide additional advantages.

### SUMMARY OF THE INVENTION

It is an object of the present embodiments to provide a humidity controllable cathode end plate as a humidity maintaining apparatus for an air breathing fuel cell stack capable of suppressing stack performance degradation by preventing the dryness of a cathode and a membrane.

It is another object of the present embodiments to provide an air breathing fuel cell stack with high reliability using the cathode end plate.

In order to accomplish the objects, there is provided an air breathing fuel cell stack according one aspect of the present embodiments, including: a membrane electrode assembly configured of an anode, a cathode, and an electrolyte membrane positioned between the anode and the cathode; a fuel supply unit coupled to the anode to supply fuel; and a cathode end plate coupled to the cathode so that the humidity of the cathode is maintained and including a first opening part for influxing ambient air and a second opening part for outfluxing the ambient air.

Preferably, the cathode end plate includes: a condensation part condensing vapor drained from the cathode; and a channel plate positioned between the cathode and the condensation part and including a channel for guiding the flow of the ambient air.

The condensation part includes a first opening part disposed at the lower side of the cathode in a gravity direction and exposing one end of the channel and a second opening part disposed at the upper side of the cathode and exposing other end of the channel.

The channel plate is formed of nonconductive material or includes a nonconductive coating layer, the depth of the channel being 2 mm to 3 mm.

The air breathing fuel cell stack of the present embodiments further includes: an absorber disposed between the condensation part and the channel plate, absorbing and storing water intending to be emitted from the cathode to the outside through the channel, and supplying moisture to the channel when the cathode is dried.

The absorber is formed of an absorbent polymer including a fluid absorbing function according to the introduction of hydrophilic group in a single chain structure or a three dimensional network through a cross link between polymer chains.

The absorbent polymer is formed of any one or more than two materials selected from a group consisting of polyacrylamide, polyacrylic acid, polymethacrylic acid, polyethylene oxide, polyvinylalcohol, gelatin, polysaccarides, sodium carboxylmethyl cellulose, and chitosan.

The absorber may be formed of any one or more than two materials selected from pulp, paper, cloth, and absorbent cotton.

The air breathing fuel cell stack can further include: a current collector positioned between the membrane electrode assembly and the cathode end plate, the current collector including a hole through which the ambient air is passed.

The air breathing fuel cell stack of the present embodiments can further include: a gasket positioned between the membrane electrode assembly and the current collector and preventing fluid leakage from a diffusion layer in the membrane electrode assembly and a fluid influxed from the outside.

There is provided a humidity maintaining apparatus for an air breathing fuel cell stack according to another aspect of the present embodiments, the humidity maintaining apparatus including: condensation part including a first opening part for influxing ambient air and a second opening part for outfluxing the ambient air, and coupled to a cathode of the stack so that vapor drained from the cathode is condensed; and a channel plate positioned between the cathode and the condensation part and including a channel guiding the flow of the ambient air.

Preferably, the first opening part of the condensation part is disposed at the lower side of the cathode in a gravity direction and exposing one end of the channel and the second opening part thereof is disposed at the upper side of the cathode and exposing other end of the channel.

The channel plate is formed of nonconductive material or includes a nonconductive coating layer, the depth of the channel being 2 mm to 3 mm.

The humidity control apparatus for the air breathing fuel cell stack of the present embodiments further includes: an absorber disposed between the condensation part and the channel plate, absorbing and storing water intending to be emitted from the cathode to the outside through the channel, and supplying moisture to the channel when the cathode is dried.

There is provided a cathode end plate for an air breathing fuel cell stack according to another aspect of the present embodiments, the cathode end plate including: a condensation part including a first opening part influxing ambient air and a second opening part outfluxing the ambient air, and coupled to a cathode of the stack so that vapor drained from the cathode; and a channel plate positioned between the cathode and the condensation part and including a channel guiding the flow of the ambient air.

Preferably, the cathode end plate for the air breathing fuel cell stack of the present embodiments further includes: an absorber disposed between the condensation part and the channel plate, the absorber absorbing and storing water intending to be emitted from the cathode to the outside through the channel, and supplying moisture to the channel when the cathode is dried.

### BRIEF DESCRIPTION OF THE DRAWINGS

These and/or other aspects and advantages of the embodiments will become apparent and more readily appreciated from the following description of the preferred embodiments, taken in conjunction with the accompanying drawings of which:

FIG. 1 is a perspective view of an air breathing fuel cell stack according to one embodiment;

FIG. 2 is a cross-sectional view of the air breathing fuel cell stack of FIG. 1 taken along line II-II;

FIG. 3 is an exploded perspective view of the air breathing fuel cell stack according to the embodiment.

### DETAILED DESCRIPTION OF PREFERRED EMBODIMENTS

Hereinafter, preferable embodiments easily carried out by those skilled in the art will be described with reference to the accompanying drawings.

In the following description, high absorption and high absorbent does not substantially involve absorption of energy and is defined by a movement of system by means of interaction of materials. In particular, there may be a movement of gas and solid, however, the description is limited to a movement of liquid. Also, in describing the following present embodiments, the thickness or size of each layer shown in the drawings can be exaggerated for convenience or clarity of explanation. Detailed descriptions of well-known functions or constitutions will be omitted so as not to obscure the subject matter of the present embodiments.

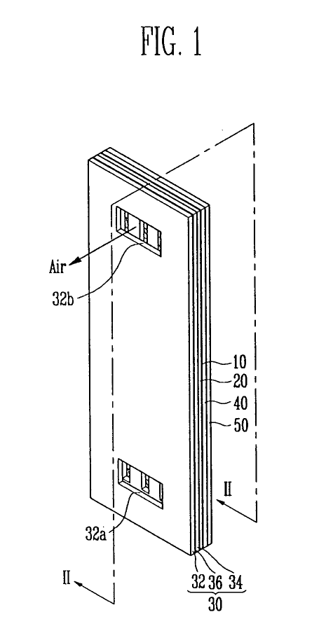

FIG. 1 is a perspective view of an air breathing fuel cell stack according to one embodiment.

Referring to FIG. 1, the air breathing fuel cell stack includes a membrane electrode assembly 10 (MEA), a cathode current collector 20, a cathode end plate 30, an anode separator 40, and an anode end plate 50.

The cathode end plate 30 includes a condensation part 32, a channel plate 34, and an absorber 36. The absorber 32 deprives thermal energy of vapor drained from a cathode by means of the electrochemical reaction of the fuel cell and emitting it to the air. The channel plate 34 is positioned between the cathode and the condensation part and guides the flow of ambient air, e.g., a flow of circulating air by means of the natural convection in the stack. The absorber 36 is disposed between the condensation part 32 and the channel plate 34, absorbing and storing water intending to be emitted from the cathode to the outside through the channel, and supplying the stored moisture to the channel when the peripheral of the cathode is dried. When viewed from a gravity direction, the lower part of the cathode end plate 30 is provided with a first opening part 32a and the upper part thereof is provided with a second opening part 32b.

The separator 40 and the anode end plate 50 facing the cathode end plate 30, putting the membrane electrode assembly 10 therebetween, are components to supply fuel to one side of the membrane electrode assembly 10 and can be modified in various forms. Therefore, the anode separator 40 and the anode end plate 50 are coupled to the anode side of the membrane electrode assembly 10 and can be referred to a fuel supply unit supplying fuel to the anode of the membrane electrode assembly.

The air breathing fuel cell stack of the present embodiment is characterized in that the cathode end plate 30 serves as a humidity controllable cathode end plate for preventing dryness of the cathode and the dryness of the electrolyte membrane due to the dryness of the cathode. Hereinafter, the technical features of the present embodiments will be described in more detail.

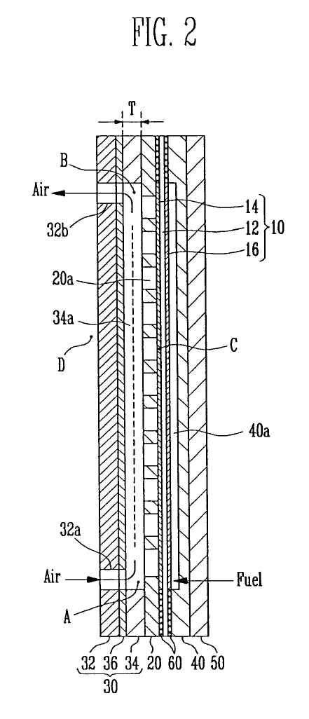

FIG. 2 is a cross-sectional view of the air breathing fuel cell stack of FIG. 1 stack taken along line II-II.

Referring to FIG. 2, in operating the air breathing fuel cell stack, after the external air is influxed through the first opening part 32a positioned at the lower of the cathode end plate 30, it passes through the channel 34a of the channel plate 34 to supply oxygen to the cathode 14 and is outfluxed through the second opening part 32a positioned at the upper of the cathode end plate 30. The influx and outflux of the external air in the air breathing fuel cell stack is based on the temperature difference between the temperatures of the lower of the stack and the lower of the stack.

More specifically, if the surface temperature of the MEA 10 is approximately 40° C. in operating the stack, the air inside the stack flows from A point of the lower of the stack, which is at a relatively low temperature, to B point of the upper of the stack, which is at a relatively high temperature. Therefore, the air outside the stack is naturally influxed into the inside of the stack through the first opening part 32a positioned at the lower of the stack. The air influxed into the inside of the stack can be outfluxed to the outside through the second opening part 32b via the channel 34 extended in a vertical direction.

As such, the air breathing fuel cell stack takes a structure capable of supplying sufficient air to the cathode using the temperature difference between the upper and lower parts of the stack.

Also, in operating the air breathing fuel cell stack, vapor and/or water from the cathode 14 is discharged to the channel 34a through a through-hole 20a of the cathode current collector 20. And, the water flows down the lower of the stack to the channel by means of gravity and is discharged through the second opening part 32b according to the flow of air. Some of the vapor discharged to the channel 34a is condensed by depriving its thermal energy by means of the condensation part 32, which is relatively cooled by means of the outside atmosphere and the absorber 36, which is installed adjacent to the condensation part 32 and then are absorbed in the absorber 36. The condensation part 32 is effectively operated when the internal temperature of the stack, for example, the temperature T1 at C point is higher than the external temperature of the stack, for example, the temperature T2 at D point. When the difference of the T1 and T2 is large, the condensation part 32 is more effectively operated.

Meanwhile, in operating the stack when the surface temperature of the MEA 10 is 50° C. or more, most vapor discharged to the channel 34a is rapidly discharged through the second opening part 32b according to the flow of air. In this case, the cathode 14 exposed to the air can easily be dried. However, in the stack structure of the present embodiments, when the cathode 14 or the peripheral of the cathode 14 is dried, the water absorbed in the absorber 36 is diffused and discharged into the channel 34 so that the humidity is restored to the peripheral of the cathode 14 and the humidity of the channel is maintained.

Preferably, the depth of the channel 34a of the channel plate 34 is from about 2 mm to about 3 mm. The depth of the channel 34a of the channel plate 34 corresponds to the depth of the opening part opening the through-hole 20a of the cathode current collector 20 to the air.

According to the forgoing present embodiments, in the air breathing fuel cell, dryness of the cathode and dryness of the polymer electrolyte membrane 12 contacting h the cathode 14 can be prevented.

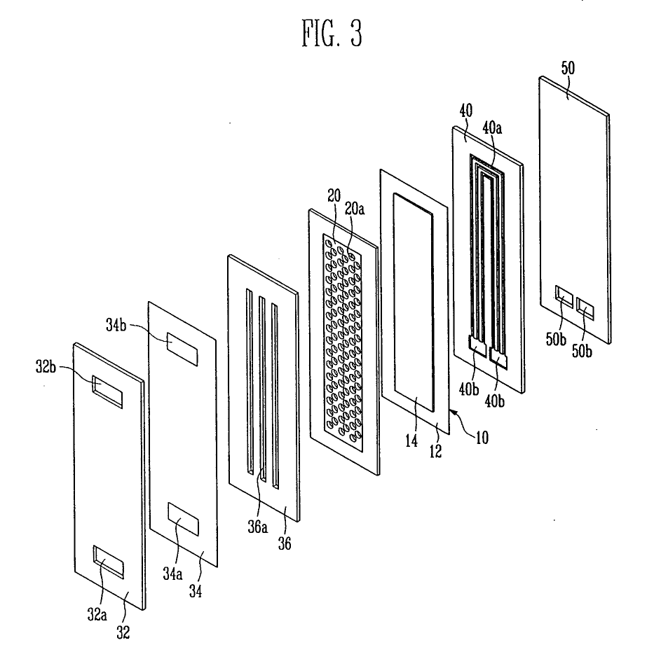

FIG. 3 is an exploded perspective view of a fuel cell stack of FIG. 1.

Referring to FIGS. 2 and 3, the MEA 10 is configured of the electrolyte membrane 12, the cathode 14, and the anode 16. Herein, the cathode 14 may be referred to as a cathode electrode and the anode electrode may be referred to as an anode electrode. The MEA 10 generates electricity by electrochemically reacting fuel supplied to the anode 16 and oxygen supplied to the cathode. As the fuel, a hydro-carbonaceous fuel, such as methanol, ethanol, and butane gas, etc., or pure hydrogen can be used, for example. In the case of using the methanol, the electrochemical reaction of the fuel cell stack can be indicated by the following reaction equation 1 and in the case of using the hydrogen, the electrochemical reaction of the fuel cell stack can be indicated by the following reaction equation 2.

Anode: CH₃OH+H₂O→CO₂+6H⁺+6e⁻

Cathode: 3/2O₂+6H⁺+6e⁻→3H₂O

Overall: CH₃OH+: 3/2O₂→CO₂+2H₂O [REACTION EQUATION 1]

Anode: H₂(g)→2H⁺+2e⁻

Cathode: 1/2O₂+2H⁺+2e⁻→H₂O

Overall: H₂+1/2O₂→H₂O [REACTION EQUATION 2]

The electrolyte membrane 12 can be manufactured in solid polymer, e.g., a proton polymer. Included in the proton conductive polymer, there may be one of more of fluorine polymer, ketonic polymer, benzimidazolic polymer, esteric polymer, amide-based polymer, imide-based polymer, sulfonic polymer, styrenic polymer, hydro-carbonaceous polymer, etc. One example of the proton conductive polymer may include, for example, poly(perfluorosulfonic acid), poly(perfluorocarboxylic acid), a copolymer of fluorovinylether and tetrafluoroethylene including sulfonic acid group, defluorinated sulfide polyetherketone, aryl ketone, poly(2,2′-(m-phenylene)-5,5′-bibenzimidazole), (poly(2,2′-(m-phenylene)-5,5′-bibenzimidazole)), poly (2,5-benzimidazole), polyimide, polysulfon, polystyrene, polyphenylene, etc. but is not limited thereto. Preferably, the electrolyte membrane 12 has a thickness of about 0.1 mm or less in order to effectively pass the proton through.

Solvents may be used when producing the electrolyte membrane 1. Here, the usable solvent includes one solvent or a mixture of at least two solvents selected from the group consisting of alcohol such as ethanol, isopropylalcohol, n-propylalcohol, and butylalcohol; water; dimethylsulfoxide (DMSO), dimethylacetamide (DMAc), and N-methylpyrrolidone (NMP).

The cathode 14 may comprise a catalyst layer, a microporous layer, and a backing layer. Similarly, the anode 16 may comprise a catalyst layer, a microporous layer, and a backing layer.

The catalyst layers of the cathode 14 and the anode 16 perform a reaction promoting a role for chemically and rapidly reacting fuel or oxidant supplied. Preferably, the catalyst layer includes at least one metal catalyst selected from a group consisting of platinum, ruthenium, osmium, alloy of platinum-ruthenium, alloy of platinum-osmium, alloy of platinum-palladium, and alloy of platinum-M (M is at least one transition metal selected from a group consisting of Ga, Ti, V, Cr, Mn, Fe, Co, Ni, Cu, and Zn). The catalyst layer may include at least one metal catalyst selected from a group consisting of platinum, ruthenium, osmium, alloy of platinum-ruthenium, alloy of platinum-osmium, alloy of platinum-palladium, and alloy of platinum-M (M is at least one transition metal selected from a group consisting of Ga, Ti, V, Cr, Mn, Fe, Co, Ni, Cu, and Zn), which are impregnated in a carrier. Any materials with conductivity can be used as the carrier, but it is preferable to use a carbon carrier.

The microporous layers of the cathode 14 and the anode 16 function to uniformly distribute and supply fuel or oxidant to each catalyst layer. In particular, the microporous layer of the cathode side functions to smoothly exhaust water generated from the catalyst layer of the cathode side. The respective microporous layers described above can be implemented by carbon layers coated on each backing layer. Also, the respective microporous layers may include at least one carbon material, for example, graphite, carbon nano tube (CNT), fullerene (C60), activated carbon, vulcan, ketjen black, carbon black, and carbon nano horn, and further include at least one binder, for example, poly(perfluorosulfonic acid), poly(tetrafluoroethylene), and fluorinated ethylene-propylene.

The backing layers of the cathode 14 and the anode 16 function to back each catalyst layer and distribute fuel, water, air, etc., to collect electricity generated, and to prevent loss of materials in each catalyst layer. The backing layer described above can be implemented by carbon base materials, such as carbon cloth, carbon paper, etc.

The cathode current collector 20 is positioned between the MEA 10 and the cathode end plate 30 and includes the through-hole 20a passing through the air influxed through the channel 34a of the channel plate 34 of the cathode end plate 30. The through-hole 20a can be formed. for example, in a circular shape, an oval shape, and a polygonal shape. The cathode current collector 20 can be implemented by materials, such as, for example, graphite, carbon, metal whose surface is coated with material with excellent corrosion resistance, or alloy with strong corrosion resistance, etc. For example, the cathode current collector 20 can comprise a stainless steel part with a structure that comprises conductive metal particles on the surface of the stainless steel which protrude and penetrate through a passivity strip foil.

The channel plate 34 serves as a part of the moisture control apparatus for properly maintaining the moisture of the cathode and serves as the inner side end plate (a first end plate) of the cathode end plate 30. The center of the channel plate 34 is provided with the channel 34a, wherein the channel 34a connects the first opening part 32a positioned at the lower part of the stack to the second opening part 32b positioned at the upper of the stack and includes an opening part opening the cathode current collector 20 to the air, penetrating through the channel plate 34. Also, the channel 34a of the channel plate 34 can be installed by being divided into a plurality of channels in order to support the cathode current collector 20 and the absorber 36 and can be formed in a straight shape, a curved shape, or an inclined shape. The channel plate 34 can be formed of materials with good mechanical strength, density, workability, corrosion resistance, and heat capacity. For example, these materials could be aluminum, alloy of stainless steel, a polymer of a composite material such as plastic, ceramic composite material, and fiber reinforced polymer composite material, etc. Also, the channel plate 34 has insulation not to be electrically connected to the cathode current collector 20, wherein the insulation of the channel plate 34 can be implemented by insulation of material itself or insulation by a coating layer on a material surface.

The absorber 36 has an opening part 36a connected to one end of the channel 34a of the channel plate 34 and corresponds to the first opening part 32a of the condensation part 32 and another opening part 36b connected to other end of the channel 34a and corresponds to the second opening part 32b of the condensation part 32. The absorber 36 may be formed of one or more materials selected from pulp, paper, cloth, and absorbent cotton. Also, the absorber 36 can be formed of a highly absorbent polymer. The absorbent polymer should be able to absorb a fluid at least 15 times the weight of the polymer itself, as well as support a sufficient amount of fluid in the state that the load is applied. Also, the high absorbent polymer can contain an aqueous solution; however, it can comprise a polymer with water insoluble properties.

The highly absorbent polymer can be formed of one or more materials selected from a group consisting of polyacrylamide, polyacrylic acid, polymethacrylic acid, polyethylene oxide, polyvinyl alcohol, gelatin, polysaccarides, sodium carboxylmethyl cellulose, and chitosan.

Also, the highly absorbent polymer may include a copolymer of polyacrylic acid or starch graft polymer obtained by graft-polymerizing starch with polyacrylic acid or polyacrylic acid-polyvinylalcohol graft polymer by a similar method to the above method. The copolymer is a representative highly absorbent polymer and as compared to other highly absorbent polymer, has excellent absorbent capabilities. The polyacrylic acid polymer forms a three dimensional network by means of a cross link and is neutralized by means of sodium hydroxide (NaOH). As propylene, which is a raw material of acrylic acid monomer, is inexpensive, the polyacrylic acid polymer should also be inexpensive so that it is suitable for use.

The condensation part 32 serves as serves as a part of the moisture control apparatus for properly maintaining the moisture of the cathode and serves as the outer side end plate (a second end plate) of the cathode end plate 30. The condensation part 32 is compressed by means of a tie means such as a tie bar or a tie band, etc., or air pressure in order to reduce contact resistance between the components of the fuel cell stack. The condensation part 32 can be provided with an aperture through which the tie means is penetrated and a terminal for outputting electricity. The condensation part 32 can be formed of materials with good mechanical strength, density, workability, corrosion resistance, and heat capacity. The materials of the condensation derivatives can be, for example, metals such as aluminum, etc., alloy of stainless steel, etc., polymer composite material such as plastic, etc., ceramic composite material, and fiber reinforced polymer composite material, etc.

The anode separator 40 includes a channel 40a for the flow of fuel and a manifold 40b connected across the channel 40a. The anode separator 40 can include a monopolar plate whose only one surface is provided with the channel. The material of the anode separator 40 can be, for example, graphite, carbon, metal whose surface is coated with material with excellent corrosion resistance, or alloy with strong corrosion resistance, etc. In particular, when stainless steel is used as the material of the separator 40, the stainless steel can be implemented with a structure wherein conductive metal particles on the surface of the stainless steel are protruded through a passivity strip foil. The anode separator 40 can be implemented by the anode current collector in a metal plate form having an opening part pattern corresponding to the channel 40a.

The anode end plate 50 includes two opening parts 50b for influxing and outletting the fuel corresponding to the manifold 40b of the anode separator 40. The materials for the anode end plate 50 can be, for example, metals such as aluminum, etc., alloy of stainless steel, etc., polymer composite material such as plastic, etc., ceramic composite material, and fiber reinforced polymer composite material, etc. Also, the anode end plate 50 has insulation that is not electrically connected to the separator 40, wherein the insulation of the separator 40 can be implemented by insulation of material itself or insulation by a coating layer on a material surface.

The gasket 60 is positioned between the MEA 10 and the channel plate 40 and between the MEA 10 and the anode separator 40, respectively, and seals the diffusion layer of the MEA 10 supervising the flow of fuel or oxidant. The gasket 60 is formed of materials with good elasticity and retention of stress against thermal cycle and can be used in a semi-hardened pad form or a hardened form after applying slurry material. The materials for the gasket 60, can be, for example, ethylene propylene rubber (EPDM), silicon, silicon-based rubber, acrylic rubber, thermoplastic elastomer (TPE), etc., for example. The gasket 60 is omitted from FIG. 3 for convenience.

The present embodiments have an advantage of properly maintaining the moisture of the cathode by preventing the cathode and the dryness of the electrolyte membrane in the air breathing fuel cell stack

Although the embodiment described above explains that the absorber of the present embodiments mounted in the stack in the cathode end plate structure is configured with the condensation part 32, the channel plate 34, and the absorber 36, the present embodiments are not limited to such a configuration. The moisture control apparatus of the present embodiments can include a structure where the absorber 36 can be omitted. For example, in the air breathing fuel cell stack adopting the moisture control apparatus where the absorber 36 is omitted, the moisture in the channel 34a is condensed by means of the condensation part 32 and then moves in the gravity direction and the water collected in the inlet of the channel 34a flows out through the first opening part 32a. Considering such a condition, the moisture control apparatus of the present embodiments can be implemented by only the condensation 32 and the channel plate 34.

Also, although the embodiment described above explains that the air breathing fuel cell stack having a structure that the cathode end plate is positioned on one surface and the anode end plate is positioned on the opposite surface is described by way of example, the present embodiments are not limited to such a configuration. For example, the present embodiments can include a structure provided with the MEA, the cathode current collector, and the cathode end plate in a surface symmetric form, putting a middle plate therebetween, wherein the middle plate includes a fuel supplying manifold instead of the anode end plate.

Also, in the embodiment described above, the anode end plate can be configured to be integrated with a fuel tank storing fuel in addition to performing the function of the basic end plate. In this case, a separate fuel tank is not required.

As described above, it is apparent that in the present embodiments, the fuel supply unit facing the cathode end plate, putting the membrane assembly therebetween, can be implemented in various forms.

With the present embodiments as described above, in the air breathing fuel cell stack operated in the state that the cathode is directly opened to the air and not adopting a balance of plants (BOP) such as a fan, a pump, a humidifier, etc for influxing the air to the cathode, it can solve the problem of the cathode being dried by the effect of the stack temperature being raised as the current density is increased and the electrode membrane is dried according to the dryness of the cathode so that it is impossible to produce power. Further, it can prevent the stack performance degradation and provide a stable operation condition for a long time. Accordingly, the reliability and life time of the air breathing fuel cell stack can be improved.

Although a few embodiments have been shown and described, it would be appreciated by those skilled in the art that changes might be made in this embodiment without departing from the principles and spirit of the present embodiments, the scope of which is defined in the claims and their equivalents.

What is claimed is:

1. An air breathing fuel cell stack including:
a membrane electrode assembly comprising an anode, a cathode, and an electrolyte membrane positioned between the anode and the cathode;
a fuel supply unit coupled to the anode configured to supply fuel; and
a cathode end plate coupled to the cathode and configured to maintain the humidity of the cathode;
wherein the cathode end plate includes a first opening part configured to influx ambient air and a second opening part configured to outflux the ambient air.

2. The air breathing fuel cell stack as claimed in claim 1, further comprising:
a condensation part configured to condense vapor drained from the cathode; and
a channel plate arranged between the cathode and the condensation part;
wherein the channel plate includes a channel for guiding the flow of the ambient air.

3. The air breathing fuel cell stack as claimed in claim 2, wherein the condensation part includes a first opening part disposed at the lower side of the cathode in a gravity direction and exposing one end of the channel; and
a second opening part disposed at the upper side of the cathode and exposing other end of the channel.

4. The air breathing fuel cell stack as claimed in claim 2, wherein the channel plate comprises nonconductive material or includes a nonconductive coating layer, wherein the depth of the is from about 2 mm to about 3 mm.

5. The air breathing fuel cell stack as claimed in claim 2, further comprising an absorber disposed between the condensation part and the channel plate, configured to absorb and store water emitted from the cathode to the outside through the channel, and configured to supply moisture to the channel when the cathode is dry.

6. The air breathing fuel cell stack as claimed in claim 5, wherein the absorber comprises an absorbent polymer having a fluid absorbing function.

7. The air breathing fuel cell stack as claimed in claim 6, wherein the absorbent polymer comprises one or more materials selected from a group consisting of polyacrylamide, polyacrylic acid, polymethacrylic acid, polyethylene oxide, polyvinyl alcohol, gelatin, polysaccarides, sodium carboxylmethyl cellulose, and chitosan.

8. The air breathing fuel cell stack as claimed in claim 5, wherein the absorber comprises one or more materials selected from pulp, paper, cloth, and absorbent cotton.

9. The air breathing fuel cell stack as claimed in claim 1, further including a current collector between the membrane electrode assembly and the cathode end plate, wherein the current collector comprises a hole through which the ambient air can be passed.

10. The air breathing fuel cell stack as claimed in claim 9, further comprising a gasket between the membrane electrode assembly and the current collector.

11. A humidity control apparatus integrally coupled to an air breathing fuel cell stack, the humidity control apparatus comprising:
a condensation part comprising a first opening part configured to influx ambient air and a second opening part configured to outflux the ambient air, wherein the condensation part is coupled to a cathode of the stack so that vapor drained from the cathode is condensed; and
a channel plate coupled between the cathode and the condensation part which comprises a channel configured to guide the flow of the ambient air.

12. The humidity control apparatus as claimed in claim 11, wherein the first opening part of the condensation part is disposed at the lower side of the cathode in a gravity direction and wherein the first opening part of the condensation part exposes one end of the channel and the second opening part thereof is disposed at the upper side of the cathode and exposes the other end of the channel.

13. The humidity control apparatus as claimed in claim 11, wherein the channel plate is formed of nonconductive material or includes a nonconductive coating layer, wherein the depth of the channel is from about 2 mm to about 3 mm.

14. The humidity control apparatus as claimed in claim 11, further comprising an absorber disposed between the condensation part and the channel plate, configured to absorb and store water emitted from the cathode to the outside through the channel, wherein the absorber supplies moisture to the channel when the cathode is dry.

15. The humidity control apparatus as claimed in claim 14, wherein the absorber comprises an absorbent polymer with a fluid absorbing function.

16. The humidity control apparatus as claimed in claim 15, wherein the absorbent polymer comprises one or more materials selected from a group consisting of polyacrylamide, polyacrylic acid, polymethacrylic acid, polyethylene oxide, polyvinylalcohol, gelatin, polysaccarides, sodium carboxylmethyl cellulose, and chitosan.

17. A cathode end plate coupled to an air breathing fuel cell stack, the cathode end plate comprising:
a condensation part including a first opening part configured to influx ambient air and a second opening part configured to outflux the ambient air, wherein the condensation part is coupled to a cathode of the stack so that vapor drained from the cathode is condensed; and
a channel plate coupled between the cathode and the condensation part and including a channel configured to guide the flow of the ambient air.

18. The cathode end plate as claimed in claim 17, wherein the first opening part of the condensation part is disposed at the lower side of the cathode in a gravity direction and wherein the first opening part exposes one end of the channel and the second opening part thereof is disposed at the upper side of the cathode and exposes the other side of the channel.

19. The cathode end plate as claimed in claim 17, wherein the channel plate is formed of nonconductive material or includes a nonconductive coating layer, wherein the depth of the channel is from about 2 mm to about 3 mm.

20. The cathode end plate as claimed in claim 17, further comprising an absorber disposed between the condensation part and the channel plate, configured to absorb and store water emitted from the cathode to the outside through the channel, and configured to supply moisture to the channel when the cathode is dry.

21. The cathode end plate as claimed in claim 20, wherein the absorber comprises an absorbent polymer with a fluid absorbing function.

22. The cathode end plate as claimed in claim 21, wherein the absorbent polymer comprises one or more materials selected from a group consisting of polyacrylamide, polyacrylic acid, polymethacrylic acid, polyethylene oxide, polyvinylalcohol, gelatin, polysaccarides, sodium carboxylmethyl cellulose, and chitosan.

23. The cathode end plate as claimed in claim 17, wherein the absorber comprises one or more materials selected from pulp, paper, cloth, and absorbent cotton.
